(19) United States
(12) Patent Application Publication
(10) Pub. No.: US 2015/0259176 A1
(43) Pub. Date: Sep. 17, 2015

(54) BELT FOR DRIVE TECHNOLOGY, PARTICULARLY A BELT-LIKE TRACTIVE ELEMENT FOR ELEVATOR TECHNOLOGY, WITH FIRE-RESISTANT PROPERTIES

(71) Applicant: ContiTech Antriebssysteme GmbH, Hannover (DE)

(72) Inventors: Hubert Goeser, Dannenberg (DE); Stephan Brocke, Hamburg (DE)

(21) Appl. No.: 14/709,015

(22) Filed: May 11, 2015

Related U.S. Application Data
(63) Continuation of application No. PCT/EP2013/068043, filed on Sep. 2, 2013.

(30) Foreign Application Priority Data
Nov. 9, 2012 (DE) 10 2012 110 769.6

(51) Int. Cl. B66B 7/06; B32B 27/08; F16G 5/20; B32B 3/18; F16G 1/12; F16G 1/10

(52) U.S. Cl. CPC B66B 7/062; F16G 1/12; F16G 1/10; F16G 5/20; B32B 3/18; B32B 27/08; B32B 2262/103; B32B 2307/54; B32B 2413/00

(57) ABSTRACT

A belt for drive technology having a belt body made from two polymer materials (A) and (B) with elastic properties and including a top layer as the belt back and a substructure with a force transfer zone and a tension member embedded in the belt body. The first material (A) contains 15 to 50% w/w of at least one fire-resistant additive and is used everywhere in the belt body where high mechanical properties are not required and the second material (B) contains 5 to 35% w/w of at least one fire-resistant additive and is used in the are of the belt body that is subjected to the highest mechanical stresses. The belt is particularly used as a tractive element for hoisting technology.

### CROSS REFERENCE TO RELATED APPLICATIONS

This application is a continuation application of international patent application PCT/EP2013/068043, filed Sep. 2, 2013, designating the United States and claiming priority from German application 10 2012 110 769.6, filed Nov. 9, 2012, and the entire content of both applications is incorporated herein by reference.

### FIELD OF THE INVENTION

The invention relates to a belt for drive technology, consisting at least of:
a belt body made from two polymer materials A and B with elastic properties, comprising a top layer as the belt back and a substructure with a power transmission zone; and,
a tension member embedded in the belt body.

### BACKGROUND OF THE INVENTION

Such belts, which are also referred to as drive belts or power transmission belts, may be formed as flat belts, V-belts, V-ribbed belts, toothed belts or as composite cables. In this respect, reference is made in particular to the following patent literature: DE 38 23 157 A1, U.S. Pat. No. 8,262,523, DE 10 2006 007 509 A1, DE 10 2007 062 285 A1, DE 10 2008 012 044 A1, WO 2005/080821 A1, U.S. patent application publication 2008/0032837, U.S. Pat. No. 3,981,206, U.S. Pat. No. 5,417,618 and U.S. Pat. No. 6,491,598.

The elasticity of a belt is achieved by the belt body, and consequently the top layer and the substructure, consisting of a polymer material with elastic properties, the two material groups elastomers and thermoplastic elastomers being particularly notable here. Especially important are elastomers based on a vulcanized rubber compound, containing at least one rubber component and compound ingredients. Used in particular as the rubber component is ethylene propylene rubber (EPM), ethylene propylene diene rubber (EPDM), (partly) hydrogenated nitrile rubber (HNBR), fluororubber (FKM), natural rubber (NR), chloroprene rubber (CR), styrene butadiene rubber (SBR), butadiene rubber (BR) or polyurethane (PU), which are unblended or blended with at least one further rubber component, in particular with one of the aforementioned types of rubber, for example in the form of an EPM/EPDM or SBR/BR blend. Especially important here is HNBR, EPM, EPDM, PU or an EPM/EPDM blend. The compound ingredients comprise at least one crosslinking agent or a crosslinking system (crosslinking agent and accelerator). Further compound ingredients are usually also a filler and/or a processing aid and/or a plasticizer and/or an antioxidant and possibly further additives, for example fibers for the purposes of reinforcement, and color pigments. In this respect, reference is made to the general art of rubber compound technology.

The belt is provided with an embedded tension member, which is formed from at least one tension strand running in the longitudinal direction of the belt. Usually multiple tension strands form a tension member layer. Especially important here is a tension strand in a cord construction, there being according to the prior art various conceptions for the material. The main types of material are: steel, polyamide (PA), aramid, polyester, glass fibers, carbon fibers, basalt, polyether ether ketone (PEEK), polyethylene terephthalate (PET), polybenzoxazole (PBO) or polyethylene-2,6-naphthalate (PEN). The tension strand is also usually prepared with an adhesive system, for example with a resorcinol formaldehyde latex (RFL), so that sustained adhesion to the surrounding polymer material is ensured. In the case of endless belts for vehicle construction, steel has become less important as a material. Tension strands of PA, PET and more recently glass and/or basalt are particularly used for these.

However, in the case of non-endless belts as tractive elements in elevator technology - a main area of attention in the text that follows—steel is of great importance as a material for tension strands, in particular in the form of steel cords, because of the high tensile force. With regard to the relevant prior art, reference is made in particular to the following patent literature: DE 10 2006 020 633 B3, DE 10 2008 018 191 A1, DE 10 2008 018 192 A1, DE 10 2008 037 537 A1, U.S. Pat. No. 8,794,387, EP 1 396 458 A2, U.S. Pat. No. 7,757,817, U.S. Pat. No. 8,550,216, U.S. patent application publication 2002/000 0346 A1 and U.S. Pat. No. 6,739,433.

Particularly the power transmission zone of a belt is provided with an abrasion-resistant coating, which additionally serves for noise reduction and moreover may also be provided with an oil-resistant finish. Used for this is a flock covering, in particular in the form of a cotton or aramid flock, a thin elastic polymer layer filled with fibers (for example aramid fibers), a textile covering, in particular in the form of a woven or knitted fabric, or a film (for example a PTFE film) or a film composite (for example a PA-PTFE film). The woven fabric is especially important. The coatings mentioned here are usually prepared in an adhesion-promoting manner on the contact side with respect to the belt body, in particular the substructure thereof, for example with RFL.

One problem with belts of any type is that the polymer material of the belt body is very combustible. In the event of a fire, the entire material of the belt body would burn away, and possibly also damage the tension member. This problem is particularly relevant in the case of a belt-like tractive element for elevator technology, in the case of which the steel tension member may then be damaged. In any event, the function, and consequently the safety, of the elevator would be compromised.

It is already known from U.S. patent application publication 2012/0329591 to provide the polymer material of a belt body that includes two different materials with fire-resistant additives. However, here the area of the belt body that is subjected to the highest mechanical stresses is the little or no fire-resistant additives, since these additives adversely influence the mechanical properties of the belt body. For example, there is an increase in the mechanical abrasion, which can lead to premature failure of the tractive means.

### SUMMARY OF THE INVENTION

Within the scope of a further development, the object of the invention is to provide a belt, in particular a tractive element for elevator technology, in the case of which the material of the belt body is distinguished by a further improvement in the fire-resistant properties without the mechanical properties of the belt body being adversely influenced.

This object is achieved by the belt body including at least two materials A and B, specifically:
a first material A, which is provided with at least one fire-resistant additive in amounts of 15 to 50% by weight and is used everywhere in the basic belt body where the high mechanical properties are not required; and,
a second material B, which is provided with at least one fire-resistant additive in amounts of 5 to 35% by weight and is used in the area of the belt body that is subjected to the highest mechanical stresses.

It has surprisingly been found that the fire-resistant properties can be enhanced, and at the same time show no adverse influences on the mechanical properties of the belt body, if the second material B is similarly provided with at least one fire-resistant additive in amounts of 5 to 35% by weight. This was unexpected, as already stated above.

Furthermore, the fire-resistant additive surprisingly has a positive influence on the coefficient of friction, and consequently on the abrasion resistance, of the material. This partially compensates for the lessening of other mechanical properties. If, however, more than 35% by weight of the fire-resistant additive is used in the material B, the mechanical weakening is usually so great that the positive effect on the coefficient of friction can no longer cancel out this adverse influence. The abrasion resistance will then generally decrease again.

The materials A and B may in this case be the same as or different from one another.

With regard to the first material A and the second material B, the following proportionate amounts within the belt body preferably apply:
first material A: 40% by weight to 95% by weight, in particular 60% by weight to 80% by weight
second material B: 60% by weight to 5% by weight, in particular 40% by weight to 20% by weight

The following substance classes are particularly used as the fire-resistant additive:
melamine phosphate, melamine polyphosphate;
melamine cyanurate;
ammonium polyphosphate;
halogenated organic compounds (for example polytetrafluoroethylene);
organic phosphoric acid esters (for example polyphosphoric acid diesters);
organic phosphonates, polyphosphonates; red phosphorus;
metal hydroxides (for example calcium hydroxide, magnesium hydroxide, aluminum hydroxide);
metal carbonates (for example calcium carbonate, magnesium carbonate); and,
glass powder, quartz powder

A single substance class, for example a melamine phosphate, or a two- or multi-component system, for example a mixture of melamine phosphate and melamine cyanurate, may be used for this.

The additives are in this case mixed substantially uniformly in the polymer matrix.

According to the invention, the proportionate amount of the fire-resistant additive for the first material A is 15% by weight to 50% by weight, preferably 15% by weight to 35% by weight.

According to the invention, the proportionate amount of the fire-resistant additive for the second material B is 5% by weight to 35% by weight, preferably 10 to 30% by weight.

A further advantage of both the material A and the material B being provided with at least one fire-resistant additive is that the method of producing the belt can be simplified. Firstly, in the course of a mixing process, a so-called batch is prepared, the batch having a relatively high concentration of fire-resistant substances. For this purpose, the basic material of the belt is mixed with the fire-resistant additives. This batch is subsequently mixed with further basic belt material for producing the material A or the material B, until the desired concentration of fire-resistant additives has been reached. As a result, a high degree of flexibility is achieved, so that it is possible to respond quickly to different customer requirements. Consequently, the material A and the material B may be the same as or different from one another.

If for example a batch is prepared from basic belt material and 50% by weight of fire-resistant additives, it must subsequently be mixed 1:1 with the basic belt material in order to obtain a proportion of additive of 25% by weight and in the ratio 1:3 in order to obtain a proportion of additive of 12.5% by weight.

The top layer of the belt, where the high mechanical properties are not required, is provided with the first material A, with its fire-resistant characteristics.

Since the substructure with its power transmission zone that is in contact with the traction sheave is subjected to the highest mechanical stresses, by contrast the second material B, with its fire-resistant characteristics, is used for it.

The area of the tension member, which also forms the transition region of the top layer and the substructure, may be in connection with the first material A and/or the second material B, the following two variants being used in particular:

The second material B is incorporated in the substructure in such a way that the tension member is partially or completely enclosed by the second material B. Consequently, the direct surroundings of the tension member similarly have fire-resistant characteristics. Such a material concept is presented in still more detail in conjunction with the embodiment according to FIG. 1.

The second material B is incorporated in the substructure in such a way that the tension member is partially or completely enclosed by the first material A. Such a material concept is likewise presented in still more detail in conjunction with the embodiment according to FIG. 2.

According to a further configurational possibility, the first material A forms the belt core and the second material B forms the belt casing. The tension member is in this case embedded in the belt core, in particular with complete enclosure of the first material A. The belt casing with the second material B preferably surrounds the belt core completely. Such a material concept is presented in still more detail in conjunction with the embodiment according to FIG. 3.

It is usually sufficient if the belt body consists exclusively of the two materials A and B, in particular in conjunction with the aforementioned two variants.

Depending on the type of belt and the position of the tension member, it may be advantageous to provide the belt body additionally with an elastic intermediate layer comprising a third material C, the tension member being embedded within this intermediate layer. A fire-resistant additive may be mixed in within this intermediate layer.

The belt body may be additionally provided with at least one embedded layer. This layer consists in particular of a textile material in the form of a woven or knitted fabric. This layer may also have a fire-resistant finish, in that for example the textile filaments are prepared with a fire-resistant agent. Similarly, the top layer and/or the power transmission zone may be additionally provided with a coating. A textile covering in the form of a woven or knitted fabric is used in particular as the coating. The woven fabric covering is especially important here. The coating may likewise have a fire-resistant finish, in that once again for example the textile filaments are prepared with a fire-resistant agent.

The belt is formed as a flat belt, a V-belt, a V-ribbed belt, a toothed belt or else as composite cables.

The belt according to the invention is used in particular as a tractive element in elevator technology, in particular with the use of composite cables, a flat belt or a toothed belt. In the event of a fire, the fire is not allowed to spread via the tractive element over the height of the entire elevator shaft. The tractive element with the material finish described does not easily catch fire and does not show any deficiencies in mechanical properties. The elevator remains operational to some extent. A further advantage is that such a tractive element cannot transfer a fire in a building from one story to the next story.

### BRIEF DESCRIPTION OF THE DRAWINGS

The invention will now be described with reference to the drawings wherein:

FIG. 1 shows a belt in the form of composite cables as a tractive element for elevator technology in interaction with a profiled traction sheave;

FIG. 2 shows a belt in the form of a flat belt as a tractive element for elevator technology in interaction with an unprofiled traction sheave; and,

FIG. 3 shows a belt in the form of a flat belt with a belt core and a belt casing as a tractive element for elevator technology in interaction with an unprofiled traction sheave.

### DESCRIPTION OF THE PREFERRED EMBODIMENTS OF THE INVENTION

FIG. 1 shows a belt 1 as a tractive element for elevator technology, to be precise in the form of composite cables with a top layer 2 as the belt back, an embedded tension member 3 with multiple tension strands running in the longitudinal direction, in the form of steel cords, and also a substructure 4. The substructure 4 has a ribbed and grooved structure, formed from ribs 5 and grooves 6. The steel cords of the tractive element 3 are in this case respectively arranged substantially within a rib 5. The substructure 4 finally comprises the power transmission zone 7, which corresponds to a correspondingly profiled traction sheave 8. With regard to design details of the traction sheave 8, reference is made for example to DE 10 2008 037 537 A1 and U.S. Pat. No. 8,794,387.

The top layer 2 and the substructure 4 form as an overall unit the elastic belt body, which is also referred to as the main body, for example on a PU basis. The belt body in this case includes a first material A and a second material B. The first material A in this case comprises the entire top layer 2, where the high mechanical properties are not required. The second material B comprises virtually the entire substructure 4 with the power transmission zone 7. There, the belt body is subjected to the highest mechanical stresses. The second material B is in this case arranged within a rib 5 of the substructure 4 and at the same time encloses virtually the entire tension member 3.

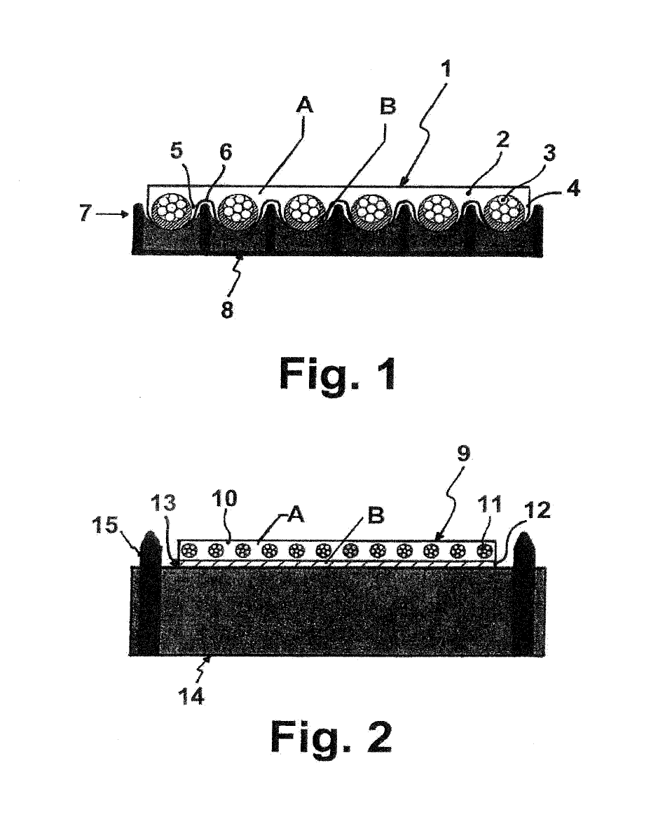

FIG. 2 shows a belt 9 as a tractive element for elevator technology, to be precise here in the form of a flat belt with a top layer 10 as the belt back, an embedded tension member 11 with multiple tension strands running in the longitudinal direction, in the form of steel cords, and also a substructure 12. Here, the substructure 12 is formed flat and comprises the power transmission zone 13, which corresponds to a traction sheave 14 with a flanged wheel 15. With regard to design details of the traction sheave 14, reference is made here for example to U.S. patent application publication 2002/0000346 A1.

Here, the top layer 10 and the substructure 12 likewise form as an overall unit the elastic belt body, for example once again on a PU basis. The belt body in this case consists of a first material A and a second material B. The first material A in this case comprises the entire top layer 10 and also the entire area of the tension member 11. This means that here all of the steel cords are completely enclosed by the first material A. The substructure 12 with the flat power transmission zone 13 is provided with the second material B.

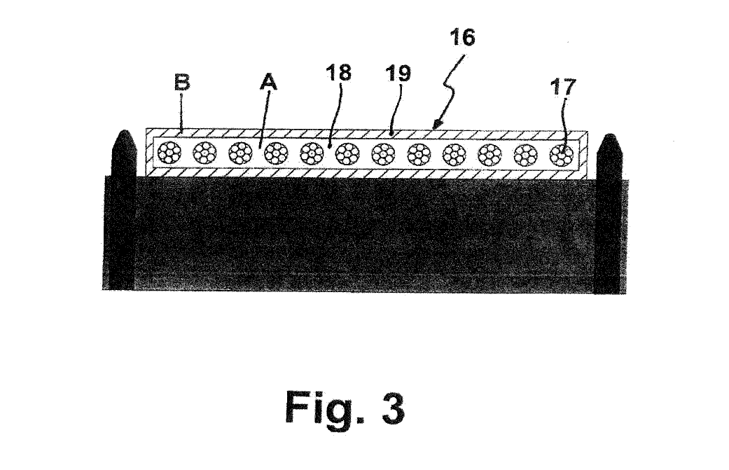

FIG. 3 shows a belt 16 as a tractive element for elevator technology, to be precise, as in the case of the embodiment 2, in the form of a flat belt. The difference is that here the first material A forms the belt core 18 and the second material B forms the belt casing 19. The tension member 17 is in this case embedded in the belt core 18, with complete enclosure of the first material A. The belt casing 19 surrounds the belt core 18 completely. The first material A consequently encloses the entire belt core 18. By contrast, the entire belt casing 19 is provided with the second material B. Consequently, the belt casing 19 with the second material B cannot burn through completely at the locations exposed to fire, while just in case the belt core 18 with the first material A prevents fire from spreading to the entire belt 16.

With regard to the traction sheave, reference is made to the embodiment according to FIG. 2.

It is understood that the foregoing description is that of the preferred embodiments of the invention and that various changes and modifications may be made thereto without departing from the spirit and scope of the invention as defined in the appended claims.

### LIST OF DESIGNATIONS

### Part of the Description

1 belt as tractive element in the form of composite cables

2 top layer as belt back

3 tension member in the form of steel cords

4 substructure

5 ribs

6 grooves

7 power transmission zone

8 traction sheave

9 belt as tractive element in the form of a flat belt

10 top layer as belt back

11 tension member in the form of steel cords

12 substructure

13 power transmission zone

14 traction sheave

15 flanged wheel

16 belt as tractive element in the form of a flat belt

17 tension member in the form of steel cords

18 belt core with embedded tension members

19 belt casing

A first material

B second material

What is claimed is:

1. A belt for drive technology comprising:
a belt body made from two polymer materials A and B with elastic properties, the belt body having a top layer as the belt back and a substructure with a power transmission zone; and,
a tension member embedded in the belt body,
wherein the first material A contains 15 to 50% by weight of at least one fire-resistant additive and is used everywhere in the belt body where the high mechanical properties are not required, and
wherein the second material B contains 5 to 35% by weight of at least one fire-resistant additive and is used in an area of the belt body that is subjected to the highest mechanical stresses.

2. The belt as claimed in claim 1, wherein the second material B contains 10 to 30% by weight of at least one fire-resistant additive.

3. The belt as claimed in claim 1, wherein the fire-resistant additive is selected from the group consisting of melamine phosphate, melamine polyphosphate, melamine cyanurate, ammonium polyphosphate, a halogenated organic compound, an organic phosphoric acid ester, an organic phosphonate, red phosphorus, a metal hydroxide, a metal carbonate, glass powder, and quartz powder, or a mixture thereof.

4. The belt as claimed in claim 1, wherein the material A is the same as the material B.

5. The belt as claimed in claim 1, wherein the material A is different from the material B.

6. The belt as claimed in claim 1, wherein the belt is formed as a flat belt, a V-belt, a V-ribbed belt, a toothed belt or as composite cables.

7. A tractive element for elevator technology comprising the belt as claimed in claim 1.
